(19) United States
(12) Patent Application Publication
(10) Pub. No.: US 2006/0190377 A1
(43) Pub. Date: Aug. 24, 2006

(54) Method and apparatus for pricing and administering a credit transaction

(76) Inventors: Michael Stanley, New York, NY (US); Michael Fisher, New York, NY (US)

Correspondence Address: BUCKLEY, MASCHOFF, TALWALKAR LLC, 5 ELM STREET, NEW CANAAN, CT, 06840, US

(21) Appl. No.: 11/360,027

(22) Filed: Feb. 22, 2006

Related U.S. Application Data
(60) Provisional application No. 60/655,006, filed on Feb. 22, 2005.

(51) Int. Cl. G06Q 40/00

(52) U.S. Cl. 705/35

(57) ABSTRACT

Systems and methods are provided to administer and price credit transactions

### CROSS-REFERENCE TO RELATED APPLICATION

The present application claims the benefit of U.S. Provisional Patent Application No. 60/655,006 entitled “Method and Apparatus for Pricing and Administering a Credit Transaction” and filed on Feb. 22, 2005.

### FIELD

The present invention relates to financial transactions. In particular, the present invention relates to systems and methods for pricing and administering a credit transaction.

### BACKGROUND

Credit default swaps are common financial transactions. A typical credit transaction involves an agreement between two counterparties, a buyer and a seller. The agreement typically obligates the buyer to pay a periodic fee to the seller in exchange for the seller's obligation to make a payment should a “credit event” occur. Essentially, the seller is selling insurance, and the buyer is buying insurance against the occurrence of the credit event (which is typically a credit event associated with a reference asset such as a bond, etc.). Many transactions are based on the “Master Agreement” maintained by the International Swaps and Derivatives Association (“ISDA”) available at www.isda.org (the definitions and contents of which are hereby incorporated by reference in their entirety for all purposes).

In general, a typical credit agreement allows a party to minimize its credit exposure to a credit event associated with a reference asset. However, the two parties assume the credit risk of each other defaulting. It would be desirable to provide a transaction that allows a party to a credit agreement to reduce the credit risk associated with a default of its counterparty. Unfortunately, however, it is difficult to price such a transaction because it is dependent on both interest rates and credit risk. It would be desirable to provide a system and method for accurately pricing such a transaction.

### BRIEF DESCRIPTION OF THE DRAWINGS

FIG. 1 is a block diagram overview of a transaction according to some embodiments.

FIG. 2 is a block diagram of a system according to some embodiments.

### DETAILED DESCRIPTION

Some embodiments of the present invention are associated with “transactions” and/or “agreements” between parties. As used herein, the terms “transaction” and/or “agreement” may refer to any arrangement between the parties. A transaction might be, for example, a legal contract defining a set of rights that exist between the parties, such as an ISDA master agreement associated with financial instruments and/or products (e.g., associated with an interest rate, a currency, a commodity, an energy value, a credit, or an equity). Note that a single agreement may be associated with more than two parties. Also note that an agreement may or may not be legally binding (e.g., an agreement may simply reflect an informal understanding between parties). In addition, as used herein the term “party” can refer to any entity associated with a transaction or agreement. A party may be, for example, a business, a business entity (e.g., a department within a business), or a person.

Credit Transaction

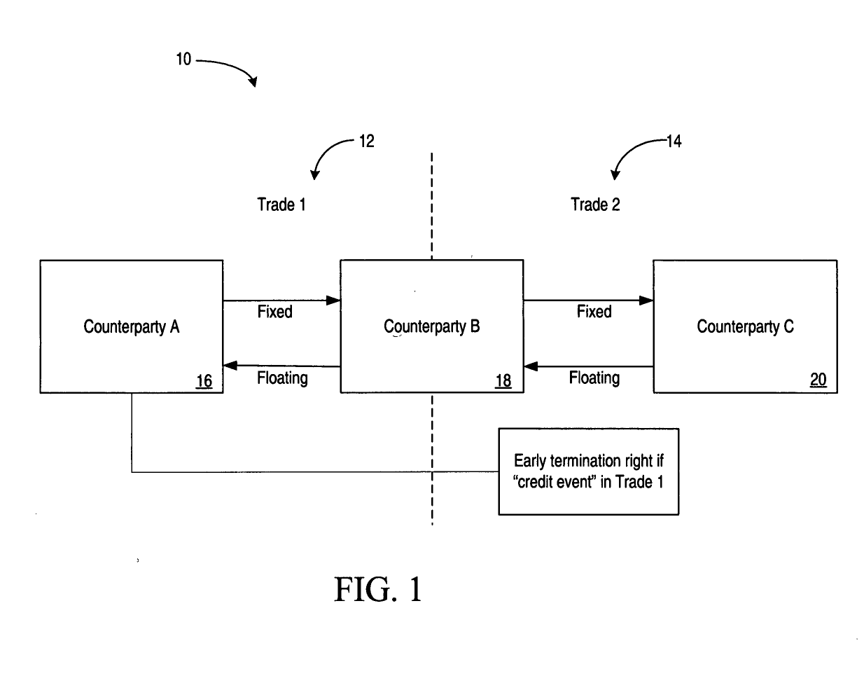

FIG. 1 is a block diagram overview of a credit transaction 10 according to some embodiments. In particular, transaction 10 involves two separate trades or transactions, involving several participants. A first trade 12 involves counterparty 16 and counterparty 18. The first trade may be a typical swap or credit agreement in which counterparty 16 is obligated to make a series of fixed payments to counterparty 18 in exchange for a floating payment from counterparty 18 to counterparty 16. The transaction may be structured using the ISDA Master Agreement or other form of agreement. In general, the first trade may be any type of transaction between the two parties in which counterparty 18 is exposed to a risk of default of counterparty 16.

A second trade 14 is entered into by counterparty 18 to hedge against the risk of default of counterparty 16. As used herein, in the terms of the second trade, counterparty 16 is the “reference counterparty”. The second trade may be, for example, a credit agreement following the ISDA Master Agreement or other form of agreement that defines a series of fixed payments to be made by counterparty 16 to counterparty 20 in exchange for a series of floating payments. Pursuant to embodiments of the present invention, the second trade includes an optional early termination provision allowing counterparty 18 (the party exposed to credit risk associated with the reference counterparty, or counterparty 16) the right to terminate and cancel the second trade involving a credit event of the reference counterparty. That is, the second trade may be terminated based on a credit event in the first trade. For example, the credit event triggering the early termination right may be defined as a bankruptcy of counterparty 16, a failure to pay by counterparty 16, or the like. In this manner, counterparty 18 is able to reduce its exposure to risk associated with the first trade.

As a specific illustrative example, the second trade may have the following terms (using the definitions provided in the ISDA Master Agreement):
Notional amount: $100,000,000 (equal to the notional amount of the first trade)
Effective Date: Jun. 5, 2004
Termination date: The earlier of (i) Jun. 5, 2021, subject to adjustment in accordance with the Modified Following Business Day Convention, (ii) in the event of early termination, the Effective Date of Cancellation as specified below under Optional Early Termination Provisions, and (iii) in the event of early termination, the Early Termination Date as specified below under Credit-linked Optional Early Termination under Additional Provisions below.
Fixed Rate Payer: Counterparty 18
Fixed Rate Payment Annually Dates:
Fixed Rate: 4.15%
Floating Rate Payer: Counterparty 20
Floating Rate Payment Annually Dates:
Floating Rate Option: USD-LIBOR-BBA
Credit-Linked In connection with this Transaction, Counterparty 20 has Optional Early granted to Counterparty 18 the option to early terminate and Termination: cancel this Transaction, in whole but not in part, without payment of any settlement amount, breakage costs, or other amounts representing the future value of this Transaction. Such early termination and cancellation shall be effective on the date of delivery of a Notice of Early Termination (the “Early Termination Date”). Following any such early termination and cancellation, the parties shall be relieved of all further payment obligations hereunder.
“Notice of Early Termination” means an irrevocable notice from Counterparty 18 to Counterparty 20 that describes a Credit Event that has occurred on or prior to the Termination Date. The Notice of Early Termination must contain a description in reasonable detail of the facts relevant to the determination that a Credit Event has occurred. The Credit Event that is the subject of the Notice of Early Termination need not be continuing on the Early Termination Date.
Credit Event The Bankruptcy or Failure to Pay by Counterparty 16.

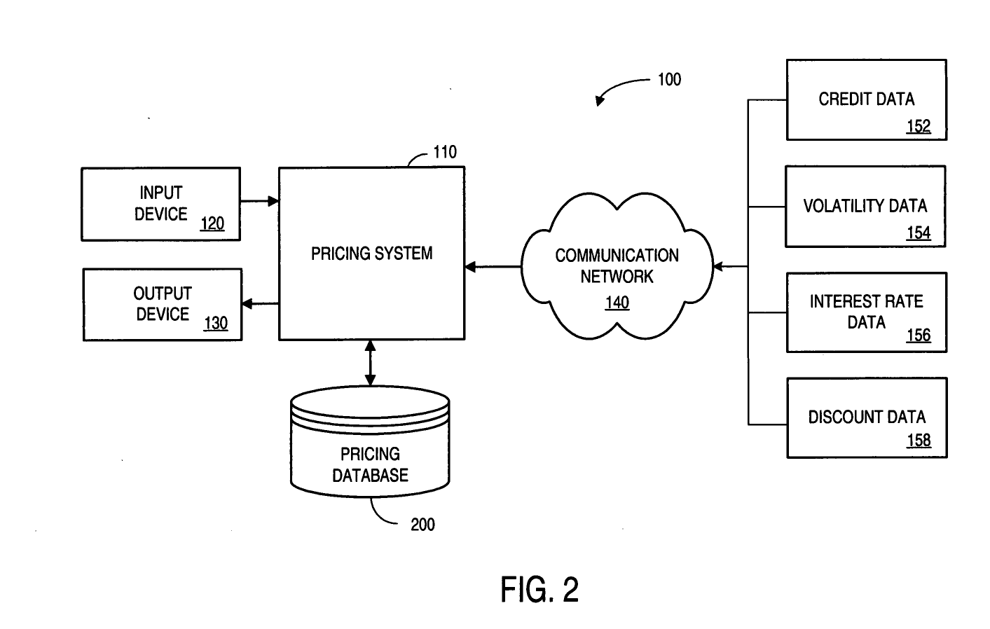

Those skilled in the art will appreciate that different or additional terms may also be used to link the termination of the second transaction to credit events associated with the first transaction. Pursuant to some embodiments, the pricing of the second transaction is based both on interest rates as well as on the likelihood of occurrence of a credit event in the first transaction. Applicants have discovered that the use of a pricing system that allows the simultaneous (or near simultaneous) calibration of interest rate and credit data provides desirable and accurate results. For example, this pricing may be performed using a pricing system such as the system of FIG. 2.

Pricing System

FIG. 2 is a block diagram overview of a system 100 according to some embodiments. System 100 includes a pricing system 110 that may receive transaction information from an input device 120. Input device 120 might be, for example, a keyboard, a database, or a remote Personal Computer (PC) associated with a user or a party to a transaction. Pricing system 110 may also provide transaction information to an output device 130. Output device 130 might be, for example, a computer monitor, a printer, a remote PC, or a system or device associated with a party to a transaction.

Pricing system 110 may also receive information from a number of data sources (such as sources 152-158) via a communication network 140. By way of example, the communication network 140 might include a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network (e.g., in accordance with an 802.11 standard), and/or an Internet Protocol (IP) network such as the Internet, an intranet, or an extranet.

Data sources providing data for use by pricing system 110 may include credit data sources 152 (e.g., such as sources of credit default swap pricing or trade information, where the price information reflects swaps of varying terms and tenors); volatility data sources 154 (e.g., such as from a credit derivative desk having information regarding options associated with counterparty 16); interest rate data sources 156 (e.g., such as price information from different actively traded swaptions); and discount data 158 (e.g., such as a discount curve for the relevant currency).

Financial information might also be received from a user (e.g., via the input device 120). For example, the user might enter financial information using a keyboard. According to still other embodiments, financial information is received from another application, such as the MICROSOFT® EXCEL spreadsheet application, or a data file.

Although a single pricing system 110 is shown in FIG. 2, any number of pricing systems 110 may be included according to embodiments of the present invention. For example, separate pricing systems may be operated by each participant (or potential participant) in a transaction. Similarly, any number of other devices or components described herein (e.g., input devices 120) may be included. Also note that different devices could be incorporated in a single physical device.

Pricing system 110 may also exchange information with a pricing database 200. For example, pursuant to some embodiments, pricing database 200 stores a series of prices calculated using a pricing model as will now be described.

Pursuant to some embodiments, system 100 may be used to price a credit-extinguishing swap (the series of trades shown and described in conjunction with FIG. 1) based on a correlation between the default intensity or hazard rate of a reference counterparty (e.g., such as counterparty 16 of FIG. 1) and interest rates. In particular, pursuant to some embodiments, this is performed using pricing system 110 using data received from one or more data sources (such as, for example, sources 152-158).

Pursuant to some embodiments, pricing system 110 is configured to calibrate to implied default probabilities given by credit default swap (CDS) prices (e.g., based on information received from credit data source(s) 152) under nonzero correlation between interest rates and credit. More particularly, this calibration is done simultaneously or substantially simultaneously for both the credit and interest rate data. By calibrating in this manner, Applicants believe more accurate and reliable results may be attained than if credit and interest rate data was correlated sequentially or independently.

Pursuant to some embodiments, pricing system 110 generates a grid or table of correlated data (e.g., stored in pricing database 200). The grid is calculated based on a two-factor diffusion model for interest rates and for the hazard rate (or, the instantaneous default intensity associated with the reference counterparty). The hazard rate and interest rate components are calibrated simultaneously (or substantially simultaneously) under the non-zero correlation assumption, in a single processing step. For calibration of the credit component, the market price of a set of benchmark CDS prices (e.g., received from credit data source(s) 152) is matched to the reference credit. For the interest rate calibration, both the discount curve and the term volatility structure are matched, as implied by the market price of a set of swaptions. Discount curve data may be received from one or more discount data source(s) 158, swaptions market prices may be retrieved from interest rate data source(s) 156, and volatility data may be received from one or more volatility data source(s) 154. The information from data sources 152-158 may be formatted and collected specifically for use with pricing system 110 or it may be retrieved from one or more publicly available sources.

More particularly, pricing system 110 may perform this correlation through use of a two-factor diffusion model (e.g., either normal or lognormal) of the form:
dX=A dt+B dZ_{—}1
dY=C dt+D dZ_{—}2
Here A,B,C and ,D can be functions of time and state, dependent on some externally specified set of parameters (p0, p1, . . . , pk, as well as X and Y themselves. dZ_1 and dZ_2 represent correlated increments of Brownian Motion. In the pricing of a credit extinguisher, the short rate is a simple transformation of the X process, and the hazard rate (instantaneous default intensity) of the reference name is a simple transformation of the Y process.

The grid or two dimensional array (e.g., stored in pricing database 200) is generated to represent the time evolution of the diffusion model at a set of discrete timepoints that cover the period of interest for pricing. Each point on the grid, (X,Y), represents a specific state. For example, given values for the parameters p1, p2, . . . , pk, pricing system 110 can be operated to price interest rate and credit default swaps, as well as more complicated structures that can be represented as a set of future cash flows that depend on the path of interest rates and counterparty default events. Pursuant to some embodiments, this pricing is performed using a backward induction method of a form known to those skilled in the art.

In this manner, pricing system 110 can be operated to generate price information for any choice of parameters p1, . . . pk which describe the diffusion model and the assets attached to it. However, arbitrary choices for the p's will not result in meaningful prices. Therefore, pursuant to some embodiments, the model is calibrated to existing prices that can be viewed in the marketplace. More particularly, the model is calibrated by first using pricing system 110 to price readily observed instruments (or instruments having known values). If the price information generated by pricing system 110 closely match the market prices, the system is correctly calibrated and the system may be used with greater confidence in pricing instruments having unknown market prices.

For example, to calibrate the interest rate portion of pricing system 110, market data is retrieved from a set of swaptions having known prices. This determines the term (interest rate) volatility structure of the system as well as the discount curve so that the system is configured to discount future cash flows in a correct manner. To calibrate the parameters which determine the form of the Y process, parameters are selected to match the prices of a set of credit default swaps (CDS) having prices marked on a daily basis (e.g., by a credit derivative trading desk or other source).

Pursuant to some embodiments, the actual fitting is done using a least squares fitter. For example, pricing system 110 is operated to describe the set of instruments to be calibrated on the grid. The prices to be matched are entered, and a least squares fit routine is operated to perform a least squares best fit on the parameters to ensure they are priced correctly. Once the correlation and fitting is accomplished, a large variety of default-sensitive structures may be priced using the calibrated grid, using standard backward induction techniques.

In this manner, the system is operated to simultaneously calibrate the interest rate and credit portions of a model while introducing a nonzero correlation between the interest rate and credit components. Further, the calibrated grid may be used to price the fixed and floating payments of the credit-extinguishing transaction described above.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
identifying a first credit transaction involving a first party and a second party in which said second party is exposed to credit risk associated with said first party; and
creating a second credit transaction involving said second party and a third party, said second party having a right to terminate said second credit transaction upon a credit event occurring in said first credit transaction.

2. The method of claim 1, wherein said creating a second credit transaction includes:
calculating a floating rate payment amount of said second credit transaction to be paid by said third party to said second party on a predetermined basis.

3. The method of claim 2, wherein said calculating a floating rate payment further comprises:
correlating a default intensity of said first party with a set of interest rates relevant to said second transaction; and
generating pricing data for each of a plurality of different interest rates.
